(19) United States
(12) Patent Application Publication
(10) Pub. No.: US 2002/0035417 A1
(43) Pub. Date: Mar. 21, 2002

(54) Locomotive wreck repair

(76) Inventors: Brian Lee Badger, Erie, PA (US); Raymond Paul Stempka, Erie, PA (US); Jeffery M. Smith, Erie, PA (US); Michael Allan Lubak, Erie, PA (US); Kathleen M. Vash, Erie, PA (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 09/838,787

(22) Filed: Apr. 20, 2001

Related U.S. Application Data
(60) Provisional application No. 60/198,562, filed on Apr. 20, 2000.

(51) Int. Cl. G05D 1/00

(52) U.S. Cl. 701/19; 105/26.05

(57) ABSTRACT

A system (100) and method for expediting the repair of a locomotive (102) having sustained damage (104) as a result of a collision. A library of as-built parts information (114) is manipulated to define a plurality of repair kits (110) each containing all of the parts necessary to repair the damage expected from a predefined collision event. A particular repair kit may be selected by a user in response to an actual collision to obtain a listing of the parts (308), a cost estimate (318) and a delivery forecast (320). All of the necessary parts may then be ordered as a unit and delivered to a repair location (106) in a single shipment, thereby minimizing the chance of missing or misplaced parts. The system may be accessed via an information network, and the selection of specific repair kit may be facilitated by the use of a graphical user interface to point-and-click on the damaged regions of the locomotive.

This application claims benefit of the Apr. 20, 2000, filing date of U.S. provisional patent application No. 60/198,562.

### FIELD OF THE INVENTION

This invention relates generally to the field of railroad transportation, and more specifically to the repair of a locomotive that has been involved in a collision, and in particular to a method for servicing a locomotive by defining repair kits including all of the parts that would be needed to repair a locomotive involved in each of a plurality of common minor collision accidents.

### BACKGROUND OF THE INVENTION

Rail transportation in the United States involves thousands of trains operating over thousands of miles of track on a daily basis. While the rail transportation industry takes great strides to achieve accident free operation, it is inevitable that at least some trains will be involved in an occasional accident. Because they most often operate at the forward end of a train, locomotives are the most likely unit of a train to sustain collision damage.

It is known to conduct collision repair services for locomotives at regional repair centers. Such repair centers may be operated by a rail company or a service provider. A wrecked locomotive is taken to a repair center where the damage is assessed, repair parts are ordered, and the necessary repairs are made to place the locomotive back into service. Locomotive downtime if very expensive for the owner of the locomotive due to the loss of revenue generation. Accordingly, fast turnaround time at repair shops would be desirable. Unfortunately, fast turnaround time at repair shops is not always achieved.

One of the principal sources of delay in the repair of a damaged locomotive is the availability of parts to perform the repair. To accomplish a collision repair, the locomotive must first be inspected to determine what parts are damaged. Those parts must then be ordered and collected at the repair location. Locomotives are large, complicated machines that are custom-built to order. Accordingly, no two locomotives are exactly the same. Even two locomotives of the same manufacturer's model number may have some different parts as a result of changes in sub-suppliers, the addition of optional features, refinements in design over time, changes/repairs completed after initial assembly, etc. Thus, the assembly of all of the necessary parts for a collision repair is complicated by the necessity of ordering the right parts for that particular locomotive.

Once all of the parts are identified and ordered, they must be collected at the repair location and stored until used. The lead time for various parts may vary from a day or two to several weeks or months. It is a common problem that some of the parts for a particular repair activity are misplaced or used for some other purpose prior to the particular repair being performed. One can understand that a repair shop may be a rather hectic environment where it is easy to misplace or misuse the hundreds of parts necessary for a collision repair. This is especially problematic when a long lead-time part is found to be missing late in the repair sequence.

### BRIEF SUMMARY OF THE INVENTION

Thus there is a particular need for a technique for shortening the time necessary to accomplish the repair of a wrecked locomotive. Accordingly, a method of preparing for the repair of a damaged locomotive is described herein, the method including: providing a database containing as-built parts information regarding a plurality of locomotives; defining a plurality of repair kits, each repair kit including those parts of a respective locomotive that would have to be replaced to repair damage to the respective locomotive caused by any one of a plurality of predefined collision events involving any one of a plurality of regions of the respective locomotive, the repair kits including parts selected from the as-built parts information of the database for the respective locomotive; communicating a user's assessment of damage to one of the regions of a selected one of the plurality of locomotives; designating a specific repair kit in response to the assessment of damage; and communicating such designation to the user.

The method of the present invention may further include collecting all of the parts included in the specific repair kit and transporting all of the parts included in the specific repair kit to a location where the damage to the selected locomotive will be repaired.

The method may further include transporting all of the parts together in a single shipment so that they are more easily applied to the repair of the locomotive with less risk of loss prior to being used for the repair.

A method of preparing for the repair of a damaged locomotive is further described as including: assessing the extent of damage to a locomotive; using a database containing as-built parts information regarding the locomotive to develop a list of parts necessary to repair the damage to the locomotive; accumulating the parts identified in the list of parts together to form a repair kit for repairing the damage to the locomotive; and shipping the repair kit as a unit to a location where the locomotive will be repaired.

A system for preparing for the repair of a damaged locomotive is described herein as having: a parts database containing information regarding the as-built parts contained in a locomotive; a plurality of repair kits defined in the parts database, each repair kit containing a grouping of all of the parts that would have to be replaced to repair damage to the locomotive caused by a respective plurality of predefined collision events; and a data port for accessing the database to select a specific repair kit in response to actual damage to the locomotive.

The system of the present invention may further include a repair kit containing all of the parts identified in a repair kit, the repair kit collected together in a condition for being transported as a single shipment.

### BRIEF DESCRIPTION OF THE DRAWINGS

The features and advantages of the present invention will become apparent from the following detailed description of the invention when read with the accompanying drawings in which:

FIG. 1 is a schematic illustration of a system that may be used for the repair of a wrecked locomotive.

FIG. 2 is a top view of a locomotive showing regions of the locomotive often damaged in a collision.

FIG. 3 is one format of a repair kit listing for a particular region of a particular locomotive.

### DETAILED DESCRIPTION OF THE INVENTION

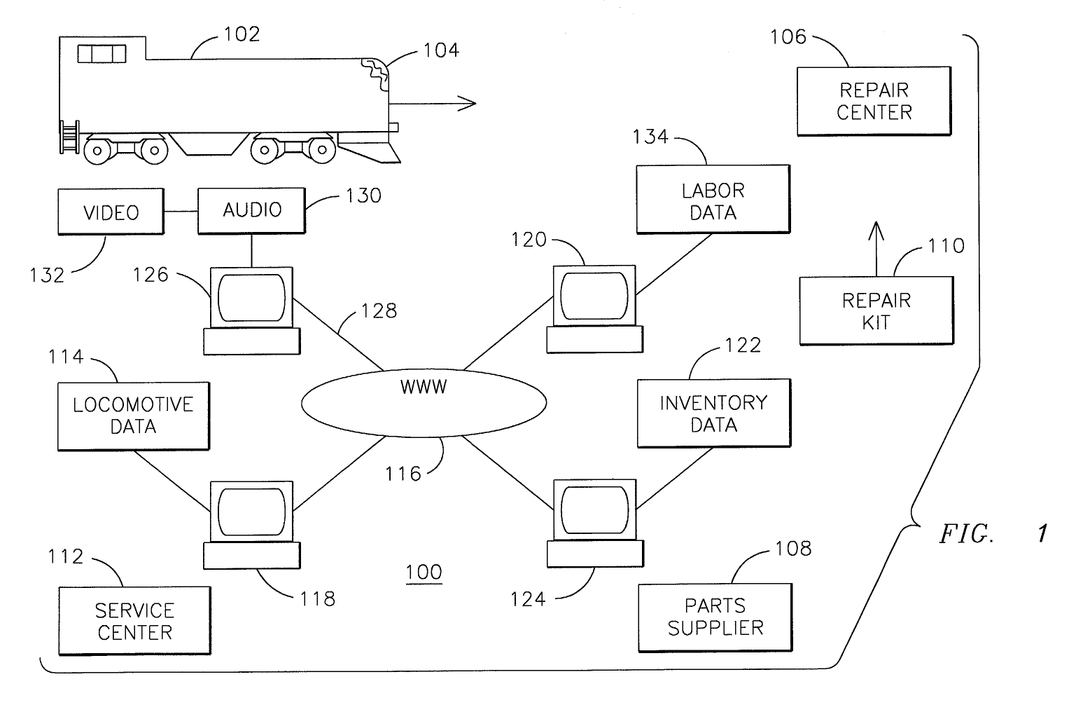

FIG. 1 is a schematic illustration of a system 100 that may be used for the repair of a locomotive 102 that has a damaged section 104 resulting from a collision or other mishap. The locomotive 102 is being transported to the location of a repair center 106 where the repairs will be made. One or more parts suppliers 108 are involved in the assembly of a repair kit 110 that is being delivered to the repair center 106 for use in the repair of the locomotive 102. As will be described more fully below, the repair kit 110 is preferably delivered as a single unit, i.e. all parts shipped together in one package or in one shipment or in a series of closely coordinated shipments containing all of the parts, drawings and instructions necessary for accomplishing the repair.

The system 100 may include a service center 112 wherein the necessary resources reside to populate and to maintain a locomotive information database 114. Locomotive database 114 may include a description of the design of a plurality of locomotives 102, complete down to an individual part level. The specific part numbers used to assemble an individual locomotive 102 are recorded, along with associated drawing/revision numbers, specification numbers, sub-part numbers, etc. as may be used by the manufacturers of locomotives to control the assembly of a locomotive 102. The extent of the type of information in the database 114 and the level of completion of the database for each locomotive may vary depending upon the other needs of a particular application. Importantly the database includes information regarding parts of the locomotive that would have to be replaced to repair damage to the locomotive caused by one or more predefined collision events. The database is preferably populated with as-built information regarding the locomotives. The term as-built is used herein to refer to the current existing condition of a locomotive, including the original manufacturing information as modified by any repairs, upgrades, substitutions, additions made to the locomotive during its useful life.

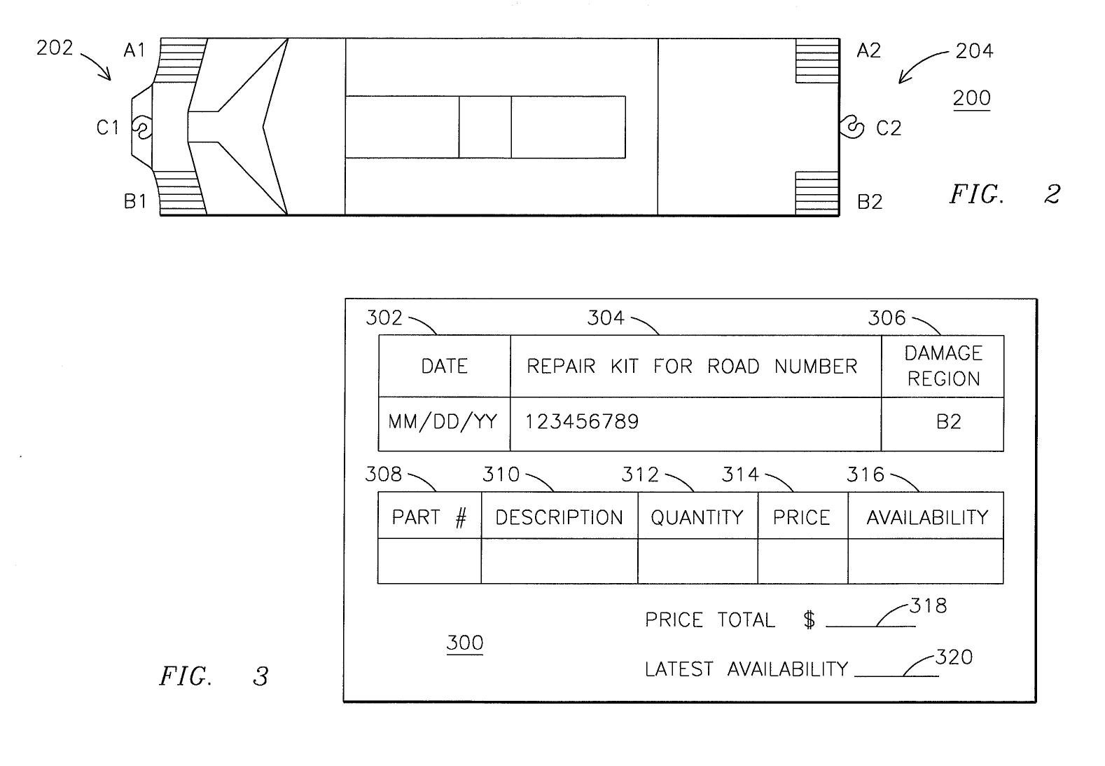

Experience resident in the resources of the service center 112 may be used to identify common or probable accident scenarios that may be encountered during the operation of locomotive 102. For example, FIG. 2 illustrates a top view of a locomotive 200 having a front end 202 and a rear end 204. In one embodiment of the present invention, six regions of locomotive 200 are identified as being susceptible to collision damage, including the four corners A1, B1, A2 and B2, the front center C1 and the rear center C2. For a collision involving any one of these regions, a list may be assembled including of all of the parts of the locomotive that are expected to be damaged. The extent of damage in each region may depend upon the energy involved in the collision, i.e. the speed of the locomotive when it collides with an object. Multiple lists may be assembled for each region of the locomotive to reflect collisions of multiple levels of severity. A typical locomotive may include relatively fragile outlying parts, such as platforms, handrails, steps, skirts, pipes, plates, etc. that would be damaged in even minor collisions due to the very large mass and inertia of a locomotive. Accordingly, this invention may be especially useful when applied to accident scenarios involving relatively light damage, since the scope of damage in such low energy collisions may be more predictable.

Referring again to FIG. 1, it may be appreciated that the locomotive database 114 may be accessed by a user at the repair center 106 or at any other location via an information network 116, such as the Internet World Wide Web. The user may be a service provider, an owner or employee of the owner of the locomotive, or any other person involved with the repair of a locomotive. Any other form of communications network may be used, for example wireless networks, telephone networks, PBX, etc. Data portals 118, 120 located at the service center 112 and repair center 106 respectively provide access to locomotive database 114 for respective service center and repair center personnel. Such data portals 118, 120 may be personal computers, portable computers, wireless data devices, or other such device known in the art. In this manner, personnel located at the repair center 106 may evaluate the damage 104 on locomotive 102 and then may access the locomotive database 114 via data portal 120. As-built information regarding the locomotive 102 may be selected by entering the specific road number or other unique identifier associated with the locomotive 102. Data portal 120 may be equipped with a graphical user interface, as is known in the art, for displaying information in text, graphical and pictorial formats. Once the user has entered the identifier for a particular locomotive 102, a pictorial representation of the locomotive, such as the one shown in FIG. 2, may be presented to the user on a display unit of the data portal 120. The user may then select the region or regions of the locomotive that are damaged at any level of detail by using a point-and-click feature or by using any other known manner of data input. If more than one level of severity is defined in the database, the user may select the level of severity that best reflects the actual damage. The selected parts may be placed in a shopping cart to be quoted by the manufacturer in a manner known in the art of e-commerce. Logic resident at any location on the information network 116 in the form of a computer program may be used to access the locomotive database 114 to select a repair kit listing corresponding to the damage information provided by the user. The repair kit would contain all of the parts that would be necessary to repair the damage to the selected region(s) of the locomotive for pre-defined collision events. The system may compile all of the parts costs and associated labor costs to calculate a quotation for repairing the damage. In lieu of using a point-and-click feature, the system may be operated using a decision tree approach for arriving at an appropriate repair kit definition. The system would present a series of questions to the user and would select parts and/or present additional questions depending upon the answer provided by the user. For example, the system 100 may present a form for inputting the road number of the locomotive 102 in question, followed by questions asking if the cab portion is damaged, if the truck portion is damaged, etc. For any portion that is damaged, additional questions may be presented to assess the extent of the damage and/or to suggest additional hidden parts that may be damaged. The resultant output may be the same as for a point-and-click system, and may even include a pictorial representation for the user to confirm those portions of the locomotive that are damaged.

FIG. 3 illustrates one format for a repair kit listing 300 as may be made available to a user upon the selection of a specific repair kit 110 for a specific locomotive 102. Because the database 114 is preferably maintained to reflect current as-built information for each locomotive in a fleet, the date 302 of the preparation of the repair kit listing 300 is important. Upgrades installed on the locomotive, changes in part numbers, obsolete parts, recalls, etc. may affect the composition of a repair kit over time. The unique identifier 304 for the particular locomotive must be shown, since different locomotives will require different repair kits for any given type of collision damage due to differences in the as-built designs of the various locomotives. The region of the locomotive 306 to be repaired by the repair kit may be included as a text description or as an alphanumeric identifier. A complete listing of all of the parts included in the repair kit may be sorted by part number 308 or part description 310. The quantity 312, price 314 and delivery availability 316 of the parts may be shown. Delivery information may be obtained by providing an appropriate interface to a parts inventory database 122, such as via a data portal 124 operated by the parts supplier 108 and accessed via the information network 116 as shown in FIG. 1. The report may provide a total price quotation 318 for the repair kit, either as an algebraic sum of the individual part prices 314 or as some other total responsive to such algebraic sum, such as including a discount, delivery charges, expediting charges, etc. A forecast ship date 320 for the repair kit may be provided as a function of the availability dates 316 for the individual parts.

In order to reduce the amount of time that a locomotive 102 must be out of service to accomplish a repair, it may be possible to use the system 100 of the present invention to identify needed repair parts and to place those parts on order before the damaged locomotive 102 arrives at the repair center 106. An operator on-board the locomotive 102 may report the location and extent of damage 104 to the repair center promptly after the damage 104 occurs. Such communication may take any form, and in one embodiment may involve the use of a data portal 126 located on-board the locomotive 102 and in communication with the repair center 106 via a wireless communication link 128 to the data network 116. Audio information 130 and/or video information 132 may be transmitted to describe the damage. In one embodiment, pictorial information may be obtained by the operator on-board the locomotive 102 in the form of a digital photograph or digital video data stream and then transmitted to the repair center 106 before the locomotive arrives at the repair center 106. Such information may allow a user at the repair center 106 to assess the damage and to select an appropriate specific repair kit 110 from among those repair kits pre-defined for that particular locomotive 102. Such selection may be done by using a computer program especially written to make such choices or to assist a human in making such choices, or it may be done by simply selecting a specific repair kit based upon the area of the locomotive that has sustained the damage. The system 100 may provide the user with cost and delivery estimates 318, 320 for obtaining the repair kit, and may allow the user to place a single order for the repair kit as a unit, thereby eliminating the need for a plurality of orders to a plurality of suppliers for all of the parts necessary to accomplish the repair of damage 104. A labor database 134 may be used to provide further information regarding the availability of skilled labor to accomplish the repair. Depending upon the availability of the necessary labor, the user may request a specific delivery date for the arrival of the repair kit 110 at the repair center 106. Advantageously, the repair kit will arrive in a single shipment on a planned date and will include all of the parts, drawings and procedures necessary to accomplish the repair of the damage 104. In this manner the repair may be accomplished without delay due to missing or misplaced parts or instructions.

Database 114 may further be populated with information regarding design changes, upgrades and optional systems that are not built into a particular locomotive but could be added during a repair activity. For example, if the addition of a new feature to lighting system of a locomotive would require the disassembly and disposal of a front light assembly, it may be advantageous to incorporate that feature during any repair involving the removal/replacement of the front light assembly. Accordingly, when a user uses system 100 to select a specific repair kit 110, the system 100 may prompt the user with information concerning optional features that may be included in the repair kit. Price/delivery information may be provided for the as-built replacement repair kit and for the upgrade repair kit. The user may then select the repair kit of choice, and appropriate drawings and installation procedures will be provided along with the corresponding parts.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. A method of preparing for the repair of a damaged locomotive, the locomotive being one of a fleet of individually unique locomotives, the method comprising:
providing a database containing as-built parts information regarding a plurality of locomotives;
defining a plurality of repair kits, each repair kit including those parts of a respective locomotive that would have to be replaced to repair damage to the respective locomotive caused by any one of a plurality of predefined collision events involving any one of a plurality of regions of the respective locomotive, the repair kits including parts selected from the as-built parts information of the database for the respective locomotive;
communicating a user's assessment of damage to one of the regions of a selected one of the plurality of locomotives;
designating a specific repair kit in response to the assessment of damage; and
communicating such designation to the user.

2. The method of claim 1, further comprising:
collecting all of the parts included in the specific repair kit;
transporting all of the parts included in the specific repair kit to a location where the damage to the selected locomotive will be repaired.

3. The method of claim 2, further comprising transporting all of the parts together in a single shipment.

4. The method of claim 3, further comprising shipping instructions for the repair of the selected locomotive together with all of the parts in a single shipment.

5. The method of claim 1, further comprising providing access to the database via an information network.

6. The method of claim 1, further comprising:
maintaining the database at a service center location;
providing access to the database via an information network; and
accessing the database from any one of a plurality of repair centers via the information network.

7. The method of claim 1, further comprising:
providing information regarding the availability of parts included in the database;
defining a delivery schedule for the specific repair kit responsive to the availability of the parts included in the specific repair kit;
providing the delivery schedule to the user upon the designation of the specific repair kit.

8. The method of claim 1, further comprising:
providing information regarding the price of parts included in the database;
defining a price quotation for the specific repair kit responsive to the prices of the individual parts included in the specific repair kit;
providing the price quotation to the user upon the designation of the specific repair kit.

9. The method of claim 1, further comprising:
directing a damaged locomotive to a repair center for repairs;
providing information regarding damage to the locomotive to the user prior to the locomotive arriving at the repair center;
designating a specific repair kit in response to the information regarding damage prior to the locomotive arriving at the repair center.

10. The method of claim 9, further comprising:
providing pictorial information regarding the damage to the selected locomotive prior to the locomotive arriving at the repair center; and
formulating the user's assessment of damage at least in part by using the pictorial information.

11. The method of claim 1, further comprising:
providing the user with a graphical representation of the one of the plurality of locomotives via a graphical user interface;
enabling the user to communicate the assessment of the damage by selecting a region of the locomotive via the graphical user interface.

12. The method of claim 1, further comprising:
enabling the user to communicate the assessment of the damage by answering a plurality of questions associated with a decision tree leading to the specific repair kit.

13. A method of preparing for the repair of a damaged locomotive, the method comprising:
providing a database containing information regarding a locomotive, the information including a listing of parts of the locomotive;
defining in the database a plurality of repair kits, each repair kit including those parts of the locomotive that would have to be replaced to repair damage to the locomotive caused by a respective plurality of predefined collision events;
providing access to the database to allow a user to select a specific repair kit from among the plurality of repair kits.

14. The method of claim 13, further comprising:
allowing the user to order for delivery all of the parts associated with the specific repair kit by ordering the specific repair kit;
delivering all of the parts associated with the specific repair kit to a locomotive repair location.

15. The method of claim 14, further comprising delivering all of the parts in a single shipment.

16. The method of claim 13, further comprising:
providing access to the database via a graphical user interface;
providing a visual representation of the locomotive via the graphical user interface, the visual representation including an indication of a section of the locomotive associated with each respective repair kit;
allowing the user to select the specific repair kit by selecting one of the sections of the locomotive via the graphical user interface.

17. The method of claim 14, further comprising delivering a repair procedure for installing the parts associated with the specific repair kit to the locomotive repair location.

18. The method of claim 13, further comprising providing cost information associated with the specific repair kit to the user.

19. The method of claim 13, further comprising providing delivery information associated with the specific repair kit to the user.

20. The method of claim 13, further comprising:
identifying an upgrade to the locomotive associated with at least one of the plurality of repair kits;
presenting information associated with the upgrade to the user in response to the user selecting a specific repair kit.

21. The method of claim 13, further comprising:
providing access to the database to the user via an information network;
providing at least one of cost information and delivery information associated with the specific repair kit to the user via the information network.

22. The method of claim 13, further comprising:
providing information concerning collision damage to the locomotive to a repair center prior to the locomotive arriving at the repair center;
selecting a specific repair kit in response to the information concerning collision damage.

23. The method of claim 22, further comprising providing the information concerning collision damage from on-board the locomotive.

24. The method of claim 23, further comprising providing pictorial information concerning collision damage via a wireless communication link.

25. A method of preparing for the repair of a damaged locomotive, the method comprising:
assessing the extent of damage to a locomotive;
using a database containing as-built parts information regarding the locomotive to develop a list of parts necessary to repair the damage to the locomotive;
accumulating the parts identified in the list of parts together to form a repair kit for repairing the damage to the locomotive; and
shipping the repair kit as a unit to a location where the locomotive will be repaired.

26. The method of claim 25, further comprising including in the repair kit instructions for installing parts included in the repair kit.

27. The method of claim 25, further comprising:
communicating pictorial information regarding the extent of the damage prior to the locomotive arriving at the location where the locomotive will be repaired; and
using the pictorial information for assessing the extent of the damage.

28. A system for preparing for the repair of a damaged locomotive, the system comprising:
a parts database containing information regarding the as-built parts contained in a locomotive;
a plurality of repair kits defined in the parts database, each repair kit containing a grouping of all of the parts that would have to be replaced to repair damage to the locomotive caused by a respective plurality of predefined collision events;
a data port for accessing the database to select a specific repair kit in response to actual damage to the locomotive.

29. The system of claim 28, further comprising a repair kit containing all of the parts identified in a repair kit selected by a user, the repair kit collected together in a condition for being transported as a single shipment.
